(19) United States
(12) Patent Application Publication
(10) Pub. No.: US 2026/0252420 A1
(43) Pub. Date: Aug. 27, 2026

(54) SCALABLE KERNEL-USERSPACE COMMUNICATION METHOD FOR USERSPACE FILESYSTEM FRAMEWORK AND APPARATUS THEREFOR

(71) Applicant: SEOUL NATIONAL UNIVERSITY R&DB FOUNDATION, Seoul (KR)

(72) Inventors: Jin-Soo KIM, Seoul (KR); Kyu-Jin Cho, Seoul (KR); Jaewon Choi, Seoul (KR); Hyungjoon Kwon, Seoul (KR)

(73) Assignee: SEOUL NATIONAL UNIVERSITY R&DB FOUNDATION, Seoul (KR)

(21) Appl. No.: 19/547,857

(22) Filed: Feb. 24, 2026

(30) Foreign Application Priority Data
Feb. 25, 2025 (KR) 10-2025-0024443

(51) Int. Cl. G06F 9/54; G06F 9/4401

(52) U.S. Cl. CPC G06F 9/545; G06F 9/4411

(57) ABSTRACT

In a scalable kernel-userspace communication method for a userspace filesystem framework performed by a processor including a plurality of cores according to one embodiment, the method may include performing, by an application, a filesystem request; receiving, by a kernel space driver, the request; transmitting, by the kernel space driver, the request to a userspace daemon using at least one of a plurality of ring channels respectively corresponding to the plurality of cores - each of the plurality of ring channels including a circular queue having a fixed size -; processing, by the userspace daemon, the request, and returning a result of the processing to the kernel space driver; and returning, by the kernel space driver, the result of the processing to the application.

### BACKGROUND OF THE INVENTION

### Field of the Invention

The present disclosure relates to a scalable kernel-userspace communication method for a userspace filesystem framework and an apparatus therefor.

Meanwhile, this application was supported by the following national research development projects.

### Subject Identification Number: 2710006872

Subject Number: II211363

Name of Ministry: Ministry of Science and ICT

Name of Subject Management (Specialized) Organization: Institute for Information & Communications Technology Planning & Evaluation

Research Project Name: SW Computing Industry Source Technology Development

Research Subject Name: (SW Star Lab) Development of Optimized Software Stack for New Concept of High-Performance Storage Apparatuses

Name of Subject Performing Organization: Seoul National University Industry-Academic Cooperation Foundation

Research Period: January 1, 2024 to December 31, 2024

### Subject Identification Number: 2710001769

Subject Number: 00222663

Name of Ministry: Ministry of Science and ICT

Name of Subject Management (Specialized) Organization: National Research Foundation of Korea

Research Project Name: Group Research Support

Research Subject Name: Center for Optimization of Large-Scale AI Models and Platforms

Name of Subject Performing Organization: Seoul National University Industry-Academic Cooperation Foundation

Research Period: March 1, 2024 to February 28, 2025

### Background of the Related Art

A computer operating system typically separates a virtual memory into a kernel space and a userspace. The kernel space is a reserved space for executing the kernel, kernel extensions, apparatus drivers, and the like. On the contrary, the userspace is a memory area in which a user mode application program operates, and the memory may be paged when needed.

The userspace is a memory area where user-level programs such as processes, applications, and libraries are executed. Most software or applications directly installed by a user on the computer operate in the userspace.

The userspace may have limited access to system resources, so it is common for programs in the userspace to interact with hardware indirectly through the kernel. From the perspective of the memory, since each program in the userspace is allocated and executed with an independent memory area, an error in any program does not affect the memory area of other programs.

Separation into two areas, the userspace and the kernel space, may provide stability, security, and management efficiency to the system. Since the kernel space and the userspace are separated from each other, an error or malicious behavior of a program in the userspace may be prevented from damaging the entire system. In terms of privilege and resource management, the kernel may allocate necessary resources (e.g., memory, CPU time, etc.) to processes in the userspace, thereby checking the privilege of the system service requested by each process to ensure a stable operation of the system. In other words, the separation into the kernel space and the userspace may be one of the fundamental design principles of an operating system, thereby preventing a program error or malicious intrusion, efficiently managing resources, and providing a stable service to the user.

A userspace filesystem (FUSE), which is the background of the present disclosure, is a framework that supports the implementation of a filesystem in the userspace, and allows filesystem functions to be implemented in the userspace while avoiding complex development within the kernel. For instance, the FUSE is a framework that allows a filesystem to be developed in the userspace, and has an advantage of allowing a custom filesystem to be developed without modifying the kernel. However, due to a single queue-based communication structure, there exist problems such as a lack of parallelism, a context switching overhead, and a request copy overhead, which cause a performance bottleneck, especially in a modern high-performance storage and multi-core environment. In order to solve the problems, several prior technologies have proposed various optimization structures, but they have shown clear limitations.

An EXTFUSE has attempted to address some of the performance issues of the FUSE through an eBPF-based extension function, but its usability is limited due to developmental limitations such as a code size limitation of eBPF, a limited pointer usage, and a restriction on kernel data access. Meanwhile, an XFUSE has attempted to increase parallelism through multiple communication channels instead of a single queue, but still failed to solve context switching overhead and lock contention problems.

### CITATION LIST

### Patent Literature

Korean Patent Registration No. 10-2263357

### SUMMARY OF THE INVENTION

A scalable kernel-userspace communication method for a userspace filesystem framework and an apparatus therefor according to one embodiment of the present disclosure are intended to improve a structure of an existing FUSE.

Furthermore, a scalable kernel-userspace communication method for a userspace filesystem framework and an apparatus therefor according to one embodiment of the present disclosure are intended to prevent limitations of an existing FUSE structure, such as performance degradation due to frequent context switching and data copy between the userspace and the kernel space.

In addition, a scalable kernel-userspace communication method for a userspace filesystem framework and an apparatus therefor according to one embodiment of the present disclosure are intended to improve overhead that is becoming more prominent in a modern computing environment in which high-performance storage apparatuses and multi-core systems are common.

Besides, an aspect of a scalable kernel-userspace communication method for a userspace filesystem framework and an apparatus therefor according to one embodiment of the present disclosure is to provide extensibility for the limitations of parallel processing of a single queue structure of an existing FUSE.

Meanwhile, problems to be solved by the present disclosure or an aspect of the present disclosure are not limited to those mentioned above, and the foregoing descriptions should be understood as exemplary.

In a scalable kernel-userspace communication method for a userspace filesystem framework performed by a processor including a plurality of cores according to one embodiment, the method may include performing, by an application, a filesystem request; receiving, by a kernel space driver, the request; transmitting, by the kernel space driver, the request to a userspace daemon using at least one of a plurality of ring channels respectively corresponding to the plurality of cores - each of the plurality of ring channels including a circular queue having a fixed size -; processing, by the userspace daemon, the request, and returning a result of the processing to the kernel space driver; and returning, by the kernel space driver, the result of the processing to the application.

Furthermore, the plurality of cores may be classified as non-uniform memory access (NUMA) nodes, and the ring channel may be implemented on a memory of the NUMA node including a core corresponding thereto.

Furthermore, the plurality of ring channels may be implemented through a shared memory between the kernel space driver and the userspace daemon.

Furthermore, processing, by the userspace daemon, the request, may include allocating a dedicated worker thread to each of the plurality of ring channels to process the request.

Furthermore, the circular queue may implement at least one of a pending queue and a processing queue.

Furthermore, the method may further include directly storing, when the request is a synchronous request, the request in the circular queue, and storing, when the request is an asynchronous request, the request in a background queue implemented outside the ring channel, and then moving the request to the circular queue.

Furthermore, the plurality of ring channels may include a header buffer and an argument buffer for storing filesystem request information associated with the request.

Furthermore, the header buffer and the argument buffer may include a bitmap for managing entry allocation information.

Furthermore, the header buffer may include a first entry storing basic information of the request and a second entry storing individually required information according to the request.

Furthermore, the argument buffer may be used for the request to transmit one or more additional parameters.

Furthermore, the ring channel including the circular queue, the header buffer and the argument buffer may be mapped to a virtual address space of the userspace daemon.

The kernel space driver may use hybrid polling to receive the result of the processing for the request for a preset period of time.

Furthermore, the hybrid polling may fall back, when the result of the processing for the request is not received for the preset period of time, to an event-wait mode.

Furthermore, the method may further include determining whether the request is concentrated on a single ring channel to cause congestion.

Furthermore, the method may further include scheduling, when it is determined that congestion has caused, a plurality of requests of a ring channel in which the congestion has caused to another ring channel in a round-robin manner.

Furthermore, the method may include storing, when the request is an asynchronous request, the request in a background queue implemented outside the ring channel, wherein a criterion for determining that the congestion has caused determines that a number of asynchronous requests stored in the background queue exceeds a preset threshold that can be stored in the circular queue at most.

Furthermore, the kernel space driver may use hybrid polling to receive the result of the processing for the request for a preset period of time, wherein when the result of the processing for the request is not received for the preset period of time, the hybrid polling falls back to an event-wait mode, and a criterion for determining that the congestion has caused includes determining that there is an application that has fallen back to the event-wait mode.

An apparatus for scalable kernel-userspace communication for a userspace filesystem framework according to one embodiment may include a memory including an instruction; and a processor having a plurality of cores that performs a predetermined operation based on the instruction, wherein the operation of the processor includes the operations of: performing, by an application, a filesystem request; receiving, by a kernel space driver, the request; transmitting, by the kernel space driver, the request to a userspace daemon using at least one of a plurality of ring channels respectively corresponding to the plurality of cores - each of the plurality of ring channels including a circular queue having a fixed size -; processing, by the userspace daemon, the request, and operation of a result of the processing to the kernel space driver; and returning, by the kernel space driver, the result of the processing to the application.

A computer program stored in a non-transitory computer-readable recording medium according to one embodiment may include, when performed on at least one processor including a plurality of cores, an instruction that allows the processor to perform the operations of: performing, by an application, a filesystem request; receiving, by a kernel space driver, the request; transmitting, by the kernel space driver, the request to a userspace daemon using at least one of a plurality of ring channels respectively corresponding to the plurality of cores - each of the plurality of ring channels including a circular queue having a fixed size -; processing, by the userspace daemon, the request, and operation of a result of the processing to the kernel space driver; and returning, by the kernel space driver, the result of the processing to the application.

A scalable kernel-userspace communication method for a userspace filesystem framework and an apparatus therefor according to one embodiment of the present disclosure may improve a structure of an existing FUSE.

Furthermore, a scalable kernel-userspace communication method for a userspace filesystem framework and an apparatus therefor according to one embodiment of the present disclosure may prevent performance degradation due to frequent context switching and data copy between a userspace and a kernel space, provide scalability for the limitations of parallel processing of a single queue structure of an existing FUSE, and effectively improve overhead in a modern computing environment in which high-performance storage apparatuses and multi-core systems are common.

In addition, a scalable kernel-userspace communication method for a userspace filesystem framework and an apparatus therefor according to one embodiment of the present disclosure may provide a scalable message communication method between a kernel and a userspace.

Moreover, a scalable kernel-userspace communication method for a userspace filesystem framework and an apparatus therefor according to one embodiment of the present disclosure may introduce a NUMA-aware ring channel structure tailored to each CPU core, thereby eliminating a lock contention problem between operation requests and maximizing the parallelism of request processing. Through this, a processing speed of data and metadata operations may be significantly improved to achieve a high scalability in a high-performance hardware environment.

A scalable kernel-userspace communication method for a userspace filesystem framework and an apparatus therefor according to one embodiment of the present disclosure may implement an efficient request transmission, thereby mapping a ring channel between the kernel and the userspace to a shared memory, and effectively reducing context switches and request copy overhead occurring in a request and response transmission process by utilizing a hybrid polling method, which can contribute to improving the overall performance of the system by minimizing a processing delay.

Besides, a scalable kernel-userspace communication method for a userspace filesystem framework and an apparatus therefor according to one embodiment of the present disclosure may provide compatibility with an existing FUSE-based filesystem (e.g., providing the same API as a FUSE) so as to implement an executable environment without modifying a program developed based on the existing FUSE-based filesystem, thereby reducing a burden of redevelopment for program developers and allowing immediate use.

In addition, a scalable kernel-userspace communication method for a userspace filesystem framework and an apparatus therefor according to one embodiment of the present disclosure may provide a design optimized for a modern hardware environment, thereby providing more effective performance improvement in a high-performance storage apparatus and multi-core system environment, exhibiting performance similar to that of an in-kernel filesystem in both data and metadata operations, and providing excellent results in terms of parallelism and throughput.

Meanwhile, the effects of the present disclosure may not be limited to the above-mentioned effects, and other technical effects which are not mentioned herein will be clearly understood by those skilled in the art from the description below.

### BRIEF DESCRIPTION OF THE DRAWINGS

FIG. 1 is a configuration diagram of an apparatus for scalable kernel-userspace communication for a userspace filesystem framework according to one embodiment of the present disclosure.

FIG. 2 is a configuration diagram showing an overall structure of a FUSE, which is an example of an existing userspace filesystem framework.

FIG. 3 is a configuration diagram showing an overall structure of an RFUSE, which is an example of a userspace filesystem framework according to one embodiment of the present disclosure.

FIG. 4 is a flowchart showing a scalable kernel-userspace communication method for a userspace filesystem framework according to one embodiment of the present disclosure.

FIG. 5 is a configuration diagram showing a structure in which a ring channel is distinguished and implemented for each NUMA node in an RFUSE, which is an example of a userspace filesystem framework according to one embodiment of the present disclosure.

FIG. 6 is a configuration diagram conceptually showing a structure of a ring channel for implementing a scalable kernel-userspace communication method for a userspace filesystem framework according to one embodiment of the present disclosure.

FIG. 7a and 7b are a diagram for explaining an exemplary operation of a circular queue included in the ring channel shown in FIG. 6.

FIGS. 8a to 8c are configuration diagrams conceptually showing a process of processing a request using hybrid polling in a scalable kernel-userspace communication method for a userspace filesystem framework according to one embodiment of the present disclosure.

FIGS. 9a and 9b are configuration diagrams conceptually showing a process of distributing a load of an asynchronous request in a scalable kernel-userspace communication method for a userspace filesystem framework according to one embodiment of the present disclosure.

FIGS. 10, 11, and 12a to 12f are comparison tables comparing performances of existing algorithms with those of an embodiment of the disclosure.

### DETAILED DESCRIPTION OF THE PREFERRED EMBODIMENT

The details of the objectives and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are "included" is an expression of an "open type", and the expression simply denotes that the corresponding elements are present, but should not be construed as excluding additional elements.

Moreover, in case where it is mentioned that one element is "connected" or "coupled" to the other element, it should be understood that one element may be directly connected to the other element, but another element may be present therebetween.

Hereinafter, various embodiments of the present disclosure will be described with reference to the accompanying drawings. However, it should be understood that the embodiments are not intended to limit the present disclosure to specific embodiments, and include various modifications, equivalents, and/or alternatives of the embodiments of the present disclosure.

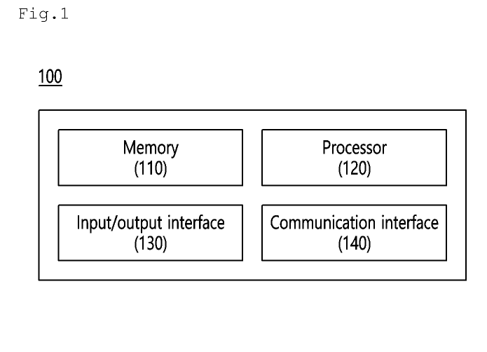

FIG. 1 is a configuration diagram of an apparatus 100 for scalable kernel-userspace communication for a userspace filesystem framework (hereinafter referred to as an 'apparatus 100') according to one embodiment.

Referring to FIG. 1, the apparatus 100 according to one embodiment may each include a memory 110, a processor 120, an input/output interface 130, and a communication interface 140.

The memory 110 may store data acquired from an external apparatus or data created by itself. The memory 110 may store instructions that can perform an operation of the processor 120. For example, the memory 110 may store various information for implementing a method for scalable kernel-userspace communication for a userspace filesystem framework to be described later. Various embodiments of the present disclosure are described by distinguishing between a kernel space and a userspace, and the kernel space and the userspace are logically distinct concepts, and may be physically implemented on the memory 110 as shown in FIG. 1.

The processor 120 is a calculation apparatus that controls an overall operation. The processor 120 may execute instructions stored in the memory 110. The processor 120 may be a multi-core processor including a plurality of cores. In addition, the plurality of cores included in the processor 120 may be designed based on a non-uniform memory access (NUMA) structure. The operation of the apparatus 100 according to an embodiment of the disclosure may be understood as an operation performed by the processor 120.

The input/output interface 130 may include a hardware interface or software interface that inputs and outputs information.

The communication interface 140 allows information to be transmitted and received through a communication network. To this end, the communication interface 140 may include a wireless communication module or a wired communication module.

The apparatus 100 may be implemented as various types of apparatuses capable of performing calculations through the processor 120 and transmitting and receiving information through a network. For example, the apparatus 100 may be implemented in a form of a server, a computer apparatus, a portable communication apparatus, a smart phone, a portable multimedia apparatus, a laptop, a tablet PC, and the like, but is not limited to those examples.

A userspace filesystem (FUSE) may be a framework that supports the implementation of a filesystem in a userspace, thereby allowing a filesystem function to be implemented in the userspace while avoiding complex development within the kernel.

The FUSE is a software interface for a Unix-like computer operating system (e.g., Unix, Linux, etc.) that allows an unprivileged user to create his or her own filesystem without modifying a kernel code. This is performed by executing a filesystem code within a userspace, where a FUSE module can provide a bridge to an actual kernel interface. For example, the FUSE is available for Linux, FreeBSD, OpenBSD, NetBSD, OpenSolaris, Minix 3, macOS, and Microsoft Windows.

Meanwhile, the term FUSE used herein is used only as a term representing a concept encompassing a framework that supports the implementation of a filesystem in a userspace, and is not limited to a specific embodiment. It is a concept that is common knowledge to those skilled in the art that even frameworks that do not use the term FUSE but provide the same or similar functions may conform to the concept of FUSE herein. For example, Dokan, one of software interfaces for Microsoft Windows, does not use the term FUSE, but it corresponds to the same concept or at least equivalent concept used herein in that programmers can create a virtual filesystem without writing a kernel-level driver.

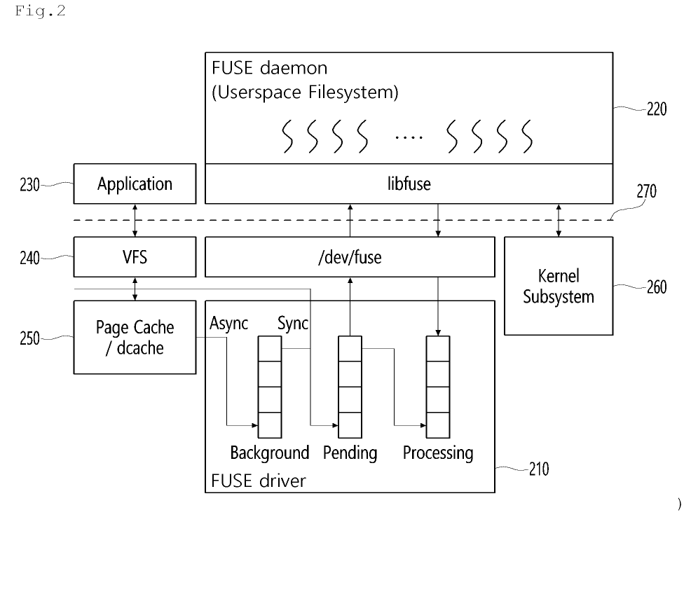

FIG. 2 is a configuration diagram showing an overall structure of a FUSE, which is an example of an existing userspace filesystem framework.

Referring to FIG. 2, the FUSE includes a FUSE driver 210, which is a kernel module, and a FUSE daemon 220 in a userspace. As shown in FIG. 2, two areas of the userspace and the kernel space may be separated based on a boundary indicated by a dotted line 270 to provide stability, security, and management efficiency of the system.

In general, a filesystem is developed at a kernel layer, which requires a deep understanding of the kernel. A FUSE may be used to create a filesystem that prioritizes ease of debugging, improved system stability, and development speed without requiring an understanding of the kernel. In other words, the FUSE is a framework that helps develop a filesystem at a user layer.

The FUSE driver 210 may be loaded into the kernel of the operating system (e.g., the Linux kernel) to interact with a virtual file system (VFS) 240, and may intercept a file system call and transmit it to the FUSE daemon 220 in the userspace.

The FUSE daemon 220 implements a user-defined file system logic, processes a file system request received from the FUSE driver 210, and returns the result to the kernel.

Such communication between the FUSE driver 210 and the FUSE daemon 220 is performed through a queue within the FUSE driver 210. The FUSE driver 210 may generally process a filesystem request through a pending queue, a background queue, and a processing queue. The pending queue may store a synchronous request Sync, and the background queue may store an asynchronous request Async. Among them, a request being processed by being transmitted to the FUSE daemon 220 may be moved to a processing queue to wait for the processing result to be returned.

Although not shown in FIG. 2, the FUSE driver 210 may further include a forget queue and/or an interrupt queue. The pending queue, background queue, and processing queue are used to route a request for a filesystem operation to the FUSE daemon 220, while the forget queue is for interaction with a directory cache (dcache), and the interrupt queue may process an interrupt request created when the kernel needs to stop a filesystem operation being performed.

According to an exemplary operation flow of a FUSE, when an application 230 performs a file system request (e.g., open, read, write a file, etc.), the request is transmitted to a FUSE driver 210 corresponding to a FUSE kernel module through a VFS 240. The FUSE driver 210 transmits that request to the FUSE daemon 220 in the userspace, and at this case, the FUSE daemon 220 communicates to receive the request by accessing it through a system call (e.g., using /dev/fuse). Then, the FUSE daemon 220 processes a request and returns the result to the FUSE driver 210 through a system call. The FUSE driver 210 transmits the received result to the original application 230 through the VFS 240 to complete a filesystem call.

The VFS 240 may be linked with a module such as a page cache/decache 250. Cache is a technique that temporarily stores frequently used data in a storage space with fast access speed to allow high-speed data input and output. With regard to cache/decache, various implementation examples within a category that can be easily understood by those skilled in the art may be adopted.

A structure of the FUSE as shown in FIG. 2 may cause performance degradation due to frequent context switching and data copy between the userspace and the kernel space. This overhead is especially noticeable in a modern environment in which high-performance storage apparatuses and multi-core systems are common. In addition, a single queue structure of the FUSE is also constrained in terms of scalability due to its limitations in parallel processing.

In order to overcome such limitations, according to embodiments of the present disclosure, a scalable kernel-userspace communication method for a userspace filesystem framework and an apparatus therefor is provided. Herein, one embodiment of the present disclosure will be described using the term RFUSE.

An RFUSE according to one embodiment of the present disclosure may introduce a new approach for maximizing performance and scalability in a modern hardware environment while integrating the strengths of existing technologies such as a FUSE.

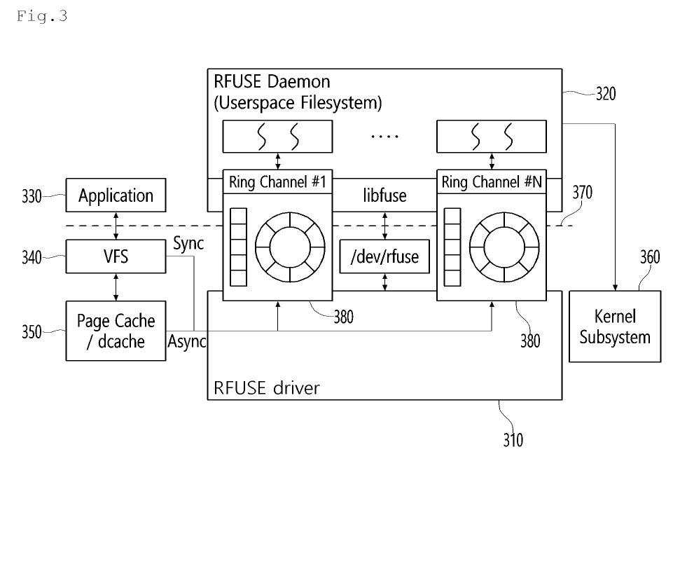

FIG. 3 is a configuration diagram showing an overall structure of an RFUSE, which is an example of a userspace filesystem framework according to one embodiment of the present disclosure.

Referring to FIG. 3, the RFUSE may include an RFUSE driver 310 in a kernel space and an RFUSE daemon 320 in a userspace. The RFUSE driver 310 may be referred to as a kernel space driver in that it exists in the kernel space, and the RFUSE daemon 320 may be referred to as a userspace daemon in that it exists in the userspace. As shown in FIG. 3, two areas of the userspace and the kernel space may be separated based on a boundary indicated by a dotted line 370 to provide stability, security, and management efficiency of the system.

The RFUSE daemon 320 implements a user-defined file system logic, processes a file system request received from the RFUSE driver 310, and returns the result to the kernel.

According to an exemplary operation flow of an RFUSE, when an application 330 performs a file system request (e.g., open, read, write a file, etc.), the request is transmitted to an RFUSE driver 310 corresponding to an RFUSE kernel module through a VFS 340. The RFUSE driver 310 transmits that request to the RFUSE daemon 320 in the userspace. In an existing FUSE structure, communication is performed by the FUSE daemon 220 using a system call (e.g., using /dev/fuse) as shown in FIG. 2, but in an RFUSE structure according to one embodiment of the present disclosure, such communication may be performed through at least one of a plurality of ring channels 380 as shown in FIG. 3. Then, the RFUSE daemon 320 processes a request and returns the result to the RFUSE driver 310 through a system call. The RFUSE driver 310 transmits the received result to the original application 330 through the VFS 340 to complete a filesystem call.

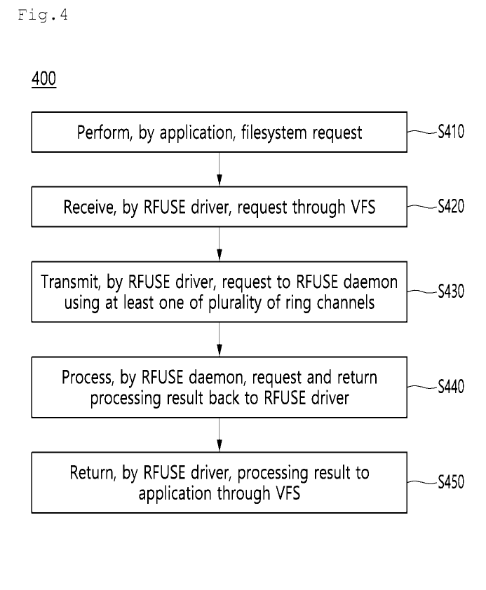

FIG. 4 is a flowchart showing a scalable kernel-userspace communication method for a userspace filesystem framework according to one embodiment of the present disclosure. For instance, FIG. 4 is a flowchart of an operation performed by the processor 120 of the apparatus 100 in conjunction with the memory 110 according to one embodiment of the present disclosure as shown in FIG. 1. For example, an exemplary method shown in FIG. 4 may be performed by an exemplary apparatus 100 shown in FIG. 1 based on an exemplary RFUSE structure shown in FIG. 3. Hereinafter, a method according to an exemplary embodiment of the present disclosure will be described with reference to FIGS. 3 and 4 together.

In step S410, the application 330 may perform a filesystem request. For example, the filesystem request may be a request to open, read, write a file or the like that can be performed on a given file on a filesystem.

In step S420, the RFUSE driver 310 may receive such a request through the VFS 340. In a process of transmitting, by the VFS 340, a request to the RFUSE driver 310, the VFS 340 may operate in conjunction with a module such as a page cache/decache 350. For instance, cache is a technique that temporarily stores frequently used data in a storage space with fast access speed to allow high-speed data input and output. With regard to cache/decache, various implementation examples within a category that can be easily understood by those skilled in the art may be adopted.

In step S430, the RFUSE driver 310 may transmit a request to the RFUSE daemon 320 using at least one of the plurality of ring channels 380. For instance, a filesystem request of the application 330 may be stored by finding a ring channel 380 based on a CPU core ID scheduled by the application 330.

Each of the plurality of ring channels 380 may include a circular queue having a fixed size. The circular queue may also be referred to as a ring buffer. Since the circular queue uses a fixed-size memory, data may be stored efficiently without dynamic memory allocation, and data input/output is fast due to increased cache efficiency due to continuous memory access. A RFUSE according to one embodiment of the present disclosure may utilize a ring buffer as a data structure for filesystem request communication. This is a communication medium for transmitting a filesystem request, allowing rapid processing of frequent channel access, and efficient management of memory usage because it is implemented with a fixed size.

In step S440, the RFUSE daemon 320 may process a filesystem request received from the RFUSE driver 310, and return the result back to the RFUSE driver 310. For instance, the RFUSE daemon 320 may return a result of processing the filesystem request to the RFUSE driver 310 through a system call.

In step S450, the RFUSE driver 310 may return the received processing result to the original application 330 through the VFS 340 to complete a filesystem call.

Each step disclosed in FIG. 4 as described above is only a preferred embodiment in achieving the objectives of the present disclosure, and some steps may be added thereto or deleted therefrom as needed, and any one step may be included in another step to be performed. The order of respective operations disclosed in FIG. 4 is only arranged for convenience of understanding, and such an order is not limited to a time series order, and the order may be changed and operated differently depending on the designer's choice.

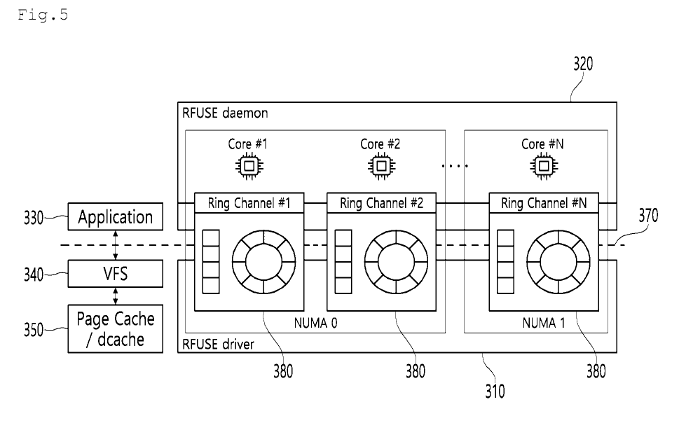

FIG. 5 is a configuration diagram showing a structure in which a ring channel is distinguished and implemented for each NUMA node in an RFUSE, which is an example of a userspace filesystem framework according to one embodiment of the present disclosure.

According to one embodiment of the present disclosure, a plurality of cores are classified into NUMA nodes, and a ring channel may be implemented on a memory of a NUMA node including a core corresponding thereto. For example, according to one embodiment of the present disclosure, as shown in FIG. 5, a plurality of cores (Core #1 to Core #N) may be classified into any one of a plurality of NUMA nodes (NUMA 0 and NUMA 1), each NUMA node may include at least one core, and a plurality of ring channels 380 may be each implemented through a memory of a NUMA node including a core corresponding thereto. According to the example of FIG. 5, a ring channel (Ring Channel #1) corresponding to a first core (Core #1) may be implemented through a memory of a NUMA node (NUMA 0) including the first core, a ring channel (Ring Channel #2) corresponding to a second core (Core #2) may be implemented through the memory of the NUMA node (NUMA 0) including the second core, and a ring channel (Ring Channel #N) corresponding to an Nth core (Core #N) may be implemented through a memory of a NUMA node (NUMA 1) including the Nth core.

In short, the ring channel 380 may be implemented in the memory of the corresponding node in consideration of the NUMA node of each allocated core. In other words, it may be understood that an RFUSE can use a NUMA-aware ring channel allocated per core for communication between the kernel space and the userspace.

In addition, according to one embodiment of the present disclosure, the plurality of ring channels 380 may be implemented through a shared memory between a kernel space driver, such as the RFUSE driver 310, and a userspace daemon, such as the RFUSE daemon 320. According to a shared memory structure between the RFUSE driver 310 and the RFUSE daemon 320, it may be performed without context switching in transmitting or receiving a file system request.

Meanwhile, according to one embodiment of the present disclosure, it may be mapped to a virtual memory space of the RFUSE when a userspace filesystem is mounted to implement the plurality of ring channels 380. In other words, when a userspace filesystem is mounted, the ring channel 380 may be allocated per CPU core and then mapped to a virtual address space of the RFUSE daemon 320. In this case, the ring channel 380 may be allocated to a memory of the corresponding core node in consideration of a NUMA structure of the mapped core.

Additionally, according to one embodiment of the present disclosure, processing of a request by the RFUSE daemon 320 may include allocating a dedicated worker thread to each ring channel 380 allocated to each core by the RFUSE daemon 320 to process a filesystem request. When a dedicated worker thread is allocated to each ring channel 380, a lock contention problem with a worker thread of another ring channel 380 may be completely eliminated so as to ensure higher scalability.

When the ring channel 380 is implemented in a memory of the corresponding node in consideration of a NUMA node of each allocated core, and implemented through a shared memory structure between the RFUSE driver 310 and the RFUSE daemon 320, and a dedicated worker thread is allocated to each ring channel 380, the ring channel 380 may maximize the parallelism of the RFUSE daemon 320 allocated to each core, eliminate lock contention, and minimize a major overhead such as context switching and memory copy when processing a request. Through this, the RFUSE may effectively eliminate the performance bottleneck that occurred in the existing FUSE. Additionally, it may provide improved performance in a workload that requires a short latency, such as a random I/O operation or metadata operation.

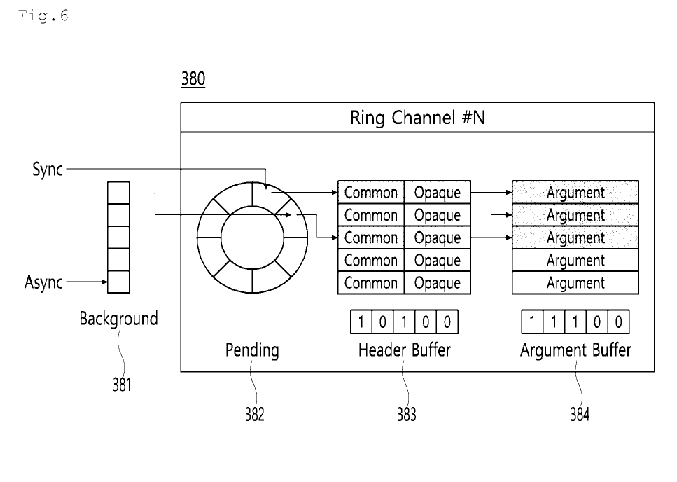

FIG. 6 is a configuration diagram conceptually showing a structure of a ring channel for implementing a scalable kernel-userspace communication method for a userspace filesystem framework according to one embodiment of the present disclosure.

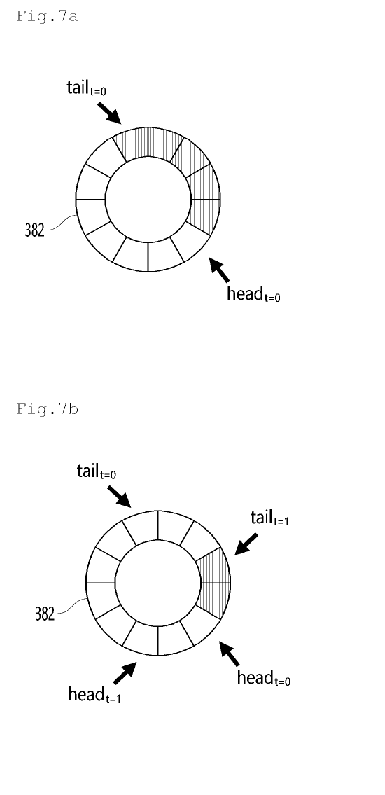

As shown in FIG. 6, each of the plurality of ring channels 380 may include a circular queue 382 having a fixed size, and FIG. 7a and 7b provide a description of an exemplary operating state of the circular queue 382 included in the ring channel shown in FIG. 6.

As shown in FIG. 7, according to one embodiment of the present disclosure, the circular queue 382 may use a fixed-sized memory space connected in a circular manner and process data in a first-in-first-out manner. The circular queue is efficient because it uses a fixed size of memory and does not require dynamic memory allocation, and has an advantage of increasing cache efficiency in that it provides continuous memory access. As shown in FIG. 7, at a specific point in time (e.g., t=0 or t=1), data stored in the circular queue 382 may be accessed through a head pointer and a tail pointer. For example, the circular queue 382 may include a fixed-size memory space for storing data, a head pointer pointing to a location where data is stored, and a tail pointer pointing to a location from which data is to be read.

For example, (a) of FIG. 7 shows a state in which five data units are stored at t=0. For instance, five predetermined data units may be sequentially input, and whenever each data unit is input, a location pointed to by the head pointer increases one by one to reach this state. (B) of FIG. 7 shows a state in which four data units are stored at t=1. For instance, in the state at t=0, three data units are deleted, and two additional data units are input, resulting in a state at t=1.

In one embodiment of the present disclosure, the circular queue 382 may be used to implement a pending queue and a processing queue. The circular queue 382 may include both a pending queue and a processing queue, but alternatively, the circular queue 382 may include only a pending queue or may include only a processing queue. For instance, due to certain constraints such as a size of the circular queue 382, the circular queue 382 may be implemented in certain variations such as including only a pending queue or only a processing queue. However, hereinafter, for convenience of understanding, embodiments are presented centering on an embodiment in which the circular queue 382 includes both a pending queue and a processing queue.

The ring channel 380 may implement the pending queue and processing queue utilized in the existing FUSE driver in the form of a circular queue (e.g., ring buffer) 382. Such a circular queue 382 may be implemented inside the ring channel 380. On the contrary, a background queue 381 may be implemented outside the ring channel 380. The pending queue may store a synchronous request Sync, and the background queue may store an asynchronous request Async. The processing queue may store a request that is being processed by the RFUSE daemon 320.

As shown in FIG. 6, according to one embodiment of the present disclosure, the method may further include directly storing, when the request is a synchronous request Sync, the request in the circular queue 382, and storing, when the request is an asynchronous request Async, the request in the background queue 381 implemented outside the ring channel 380 and then moving the request to the circular queue. Determining whether the request is a synchronous or asynchronous request to store the request in either the circular queue 382 or the background queue 381 may be included in step S430 of FIG. 4 and executed as a part thereof or as a sub-step thereof.

The asynchronous request may be first stored in the background queue 381 prepared outside the ring channel 380, and then moved to the circular queue 382 and stored therein within a range that does not exceed a predetermined threshold number defined in advance.

As shown in FIG. 6, according to one embodiment of the present disclosure, the ring channel 380 may include a header buffer 383 and an argument buffer 384 for storing filesystem request information. In addition, entry allocation information may be managed through a data structure such as a bitmap to manage information stored in each of the header buffer 383 and the argument buffer 384. For example, as shown in FIG. 6, it may be seen that the bitmap for indicating information of data allocated to the header buffer 383 stores data in the first and third spaces of the header buffer 383 as the first and third bits are indicated as 1. Additionally, it may be seen that the argument buffer 384 stores data in the first, second, and third spaces of the argument buffer 384, respectively, as the first, second, and third bits are each indicated as 1.

The header buffer 383 may be implemented by distinguishing between a first entry and a second entry. For example, the first entry may be a common entry that stores basic information for a filesystem request, and the second entry may be an opaque entry that stores information individually required according to a filesystem request.

Referring to the diagram shown in FIG. 6, the circular queue 382 stores two requests, one of which is a synchronous request Sync so as to be stored directly in the circular queue 382, while the other is an asynchronous request Async so as to be stored in the background queue 381 implemented outside the ring channel 380 and then moved to the circular queue and stored therein.

In the example of FIG. 6, a synchronous request indicated by Sync corresponds to the first entry of the header buffer 383 and may also correspond to the first and second entries of the argument buffer 384. In the example of FIG. 6, an asynchronous request indicated by Async corresponds to the third entry of the header buffer 383 and also corresponds to the third entry of the argument buffer 384. However, this is only an example, and such an example may be modified in a process of executing an embodiment of the present disclosure, and the scope of the present disclosure is not limited to the example.

The argument buffer 384 may also be used for a filesystem request that requires transmitting an additional parameter, such as a location of a file, such as RENAME. There may be one or more entries in the argument buffer 384 corresponding to one request. For instance, as described above, a synchronous request indicated by Sync in FIG. 6 may use two entries, such as a first entry and a second entry of the argument buffer 384.

The ring channel 380 including data structures such as the aforementioned circular queue 382, header buffer 383, and argument buffer 384 may be mapped to a virtual address space of the RFUSE daemon 320. When mapped to the virtual address space, it may guarantee an improved latency compared to the existing FUSE because there is no need to call system calls to access these structures.

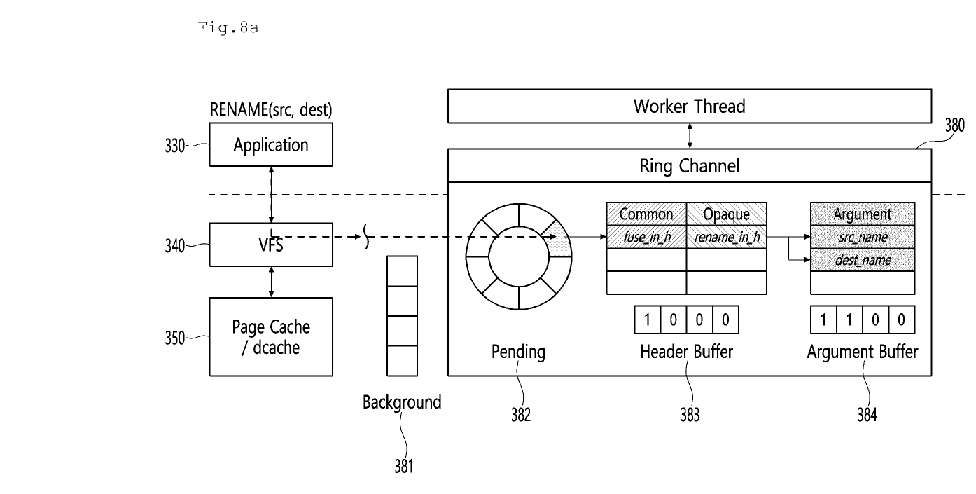

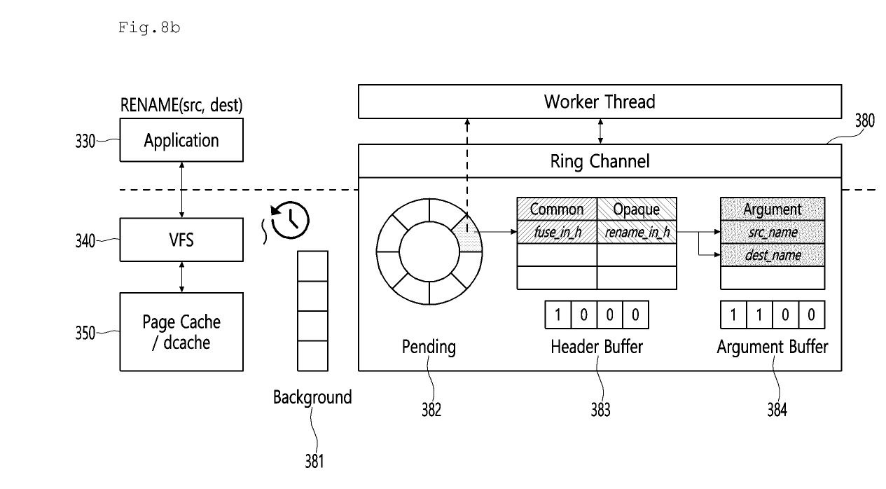

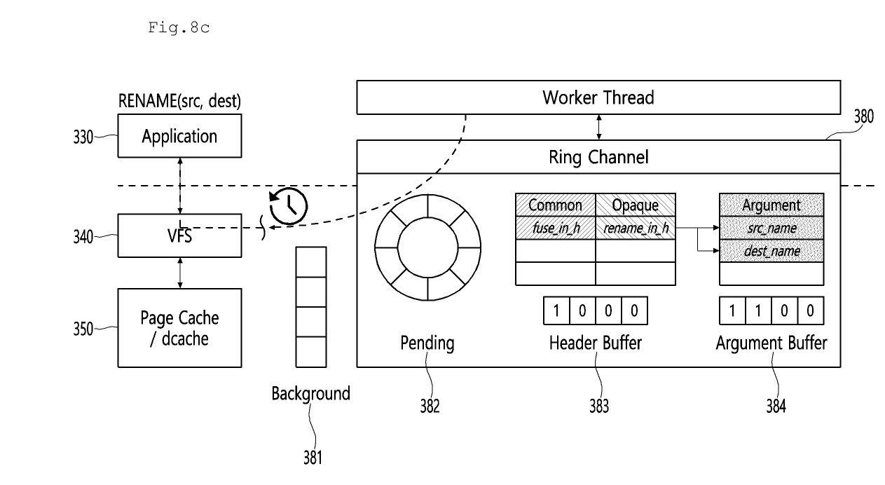

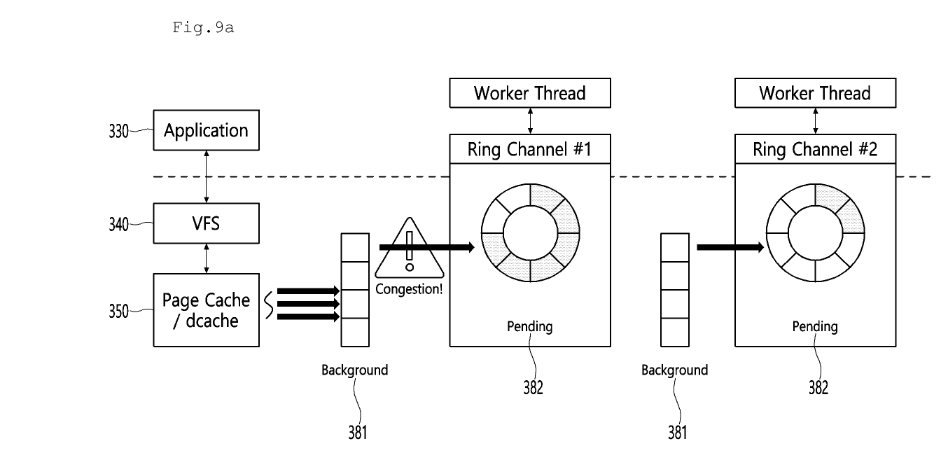

According to one embodiment of the present disclosure, a kernel space driver may use hybrid polling to receive a processing result for a request over a preset period of time. Hereinafter, the hybrid polling technique will be described with reference to FIGS. 8A to 8C.

FIGS. 8A to 8C are configuration diagrams conceptually showing a process of processing a request using hybrid polling in a scalable kernel-userspace communication method for a userspace filesystem framework according to one embodiment of the present disclosure.

Polling is a technique that allows a process to operate in a busy-waiting state to check a state of an apparatus or program, which performs processing such as transmitting or receiving data when a specific condition is satisfied. Polling may also eliminate a delay associated with waking up a thread from a sleep state as well as context switching caused by a system call.

According to one embodiment of the present disclosure, an RFUSE framework may quickly receive a filesystem request result by allowing the application 330 waiting for a result from the RFUSE driver 310 to check the ring channel 380 in a busy-waiting state using a polling technique.

For example, as shown in FIG. 8a, when the application 330 transmits a RENAME(src, dest) request to the RFUSE driver 310 through the VFS 340, data related to the corresponding request is stored in the circular queue 382, the header buffer 383, and the argument buffer 384 within the ring channel 380. Based on the data, a result of the request may be received from the RFUSE daemon 320, and the application 330 may use the polling technique to effectively eliminate an overhead in an event-wait mode of the kernel that has occurred in a method of sleeping and waking up a thread of the application 330 in an existing FUSE.

However, using polling simply may lead to a waste of CPU resources. Therefore, according to one embodiment of the present disclosure, when a processing result for the request is not received for a preset period of time, hybrid polling may fall back to an event-wait mode.

For example, as shown in FIG. 8b, a thread of the application 330 may fall back to an existing event-wait mode when not receiving a processing result even for a predetermined preset period of time (e.g., 50 μsec). That is, the thread of the application 330 may wait in a sleep state and then wake up when an event occurs. For instance, when an event related to the completion of processing for a request occurs, the thread of the application 330 may transmit a processing result to the VFS 340 through the ring channel 380 via a worker thread as shown in FIG. 8c, and the processing result transmitted in this way is returned to the application 330.

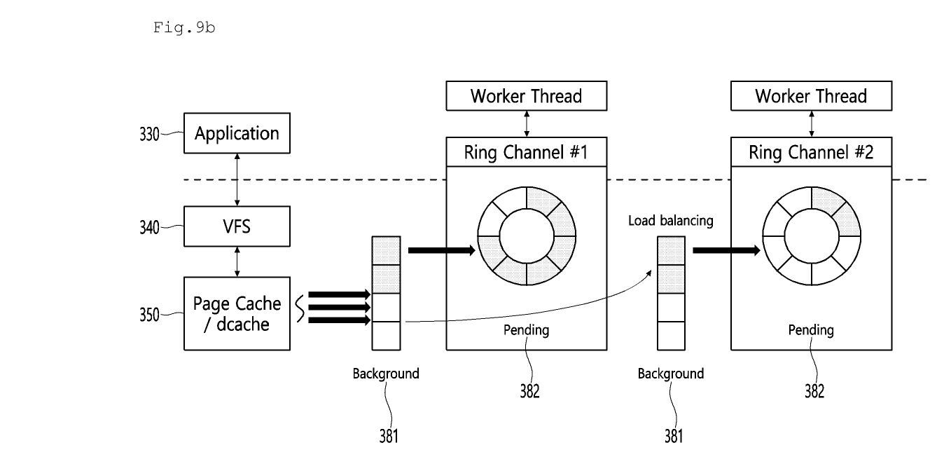

FIGS. 9A and 9B are configuration diagrams conceptually showing a process of distributing a load of an asynchronous request in a scalable kernel-userspace communication method for a userspace filesystem framework according to one embodiment of the present disclosure.

A method according to one embodiment of the present disclosure may further include determining whether a filesystem request is concentrated on a single ring channel 380 to cause congestion. As previously described, an RFUSE framework may use a ring channel 380 allocated per core and select, when a filesystem request is transmitted, the ring channel 380 based on a core ID to transmit the request to a worker thread of the RFUSE daemon 320. In this case, when a large number of requests are transmitted simultaneously from one process (e.g., in the case of readahead of the VFS 340), the requests may be concentrated on the single ring channel 380 to cause congestion.

A method according to one embodiment of the present disclosure may further include scheduling, when it is determined that congestion has caused, a plurality of requests of the ring channel 380 in which the congestion has caused to another ring channel in a round-robin manner. For example, when congestion is caused on a first ring channel (ring channel #1) as shown in FIG. 9a, a load may be distributed by scheduling a plurality of requests for the first ring channel (ring channel #1) to be processed on a second ring channel (ring channel #2) as shown in FIG. 9b.

According to one embodiment of the present disclosure, a method of searching for another ring channel according to a round-robin method may adopt a method of searching for a subsequent ring channel within the same NUMA node. However, this is an exemplary implementation example, and the present disclosure is not limited thereto.

A criterion for determining congestion may be appropriately selected depending on a system environment. According to one embodiment of the present disclosure, it may be determined that congestion has caused when a number of asynchronous requests stored in the background queue 381 exceeds a number of asynchronous requests that can be stored in the circular queue 382 at most. The number of asynchronous requests that can be stored in the circular queue 382 at most may follow a value predefined in the RFUSE framework.

A criterion for determining congestion may be differently selected depending on a system environment. According to another one embodiment of the present disclosure, when performing a hybrid polling technique for the ring channel 380, it may be determined that congestion has caused when there is at least one application that has fallen back to an event-wait mode.

By utilizing a load distribution technique to resolve congestion, an RFUSE according to embodiments of the present disclosure may increase parallelism in asynchronous request processing and use rate of ring channels to improve throughput.

The various embodiments of the present disclosure as described above may be implemented alone or in combination with other embodiments. For instance, embodiments of the present disclosure may be combined to provide the following implementation examples.

Implementation Example 1: When a userspace filesystem is mounted, the ring channel 380 may be allocated one by one per CPU core, and then mapped to a virtual address space of the RFUSE daemon 320. In this case, the ring channel 380 may be allocated to a memory of the corresponding core node in consideration of a NUMA structure of the mapped core.

Implementation Example 2: A filesystem request of the application 330 is transmitted to the RFUSE driver 310 via the VFS 340. The transmitted request may find and store the ring channel 380 based on a CPU core ID scheduled by the application 330.

Implementation Example 3: A synchronous request is stored directly in a pending ring buffer 382 implemented as a circular queue. An asynchronous request may be first stored in the background queue 381 prepared outside the ring channel, and then moved to the pending ring buffer 382 by scheduling so as not to exceed a maximum number of asynchronous requests that can be stored in the pending ring buffer 382 defined in advance. In this case, a parameter for processing a filesystem request may be transmitted through the header buffer 383 and the argument buffer 384.

Implementation Example 4: The application 330 that has stored the request may wait for a result of the request in a busy-waiting state for a predetermined period of time. When no result is returned within a predetermined period of time, the application may be switched to a sleep state.

Implementation Example 5: A worker thread created by the RFUSE daemon 320 may receive a filesystem request from the ring channel 380 mapped thereto and perform the implemented filesystem logic.

Implementation Example 6: Subsequent to processing the filesystem request, the header buffer 383 and the argument buffer 384 in the ring channel 380 are reused to transmit a result of the request. In this case, when the application 330 to receive the result is in a sleep state, the application 330 may wake up to receive the result.

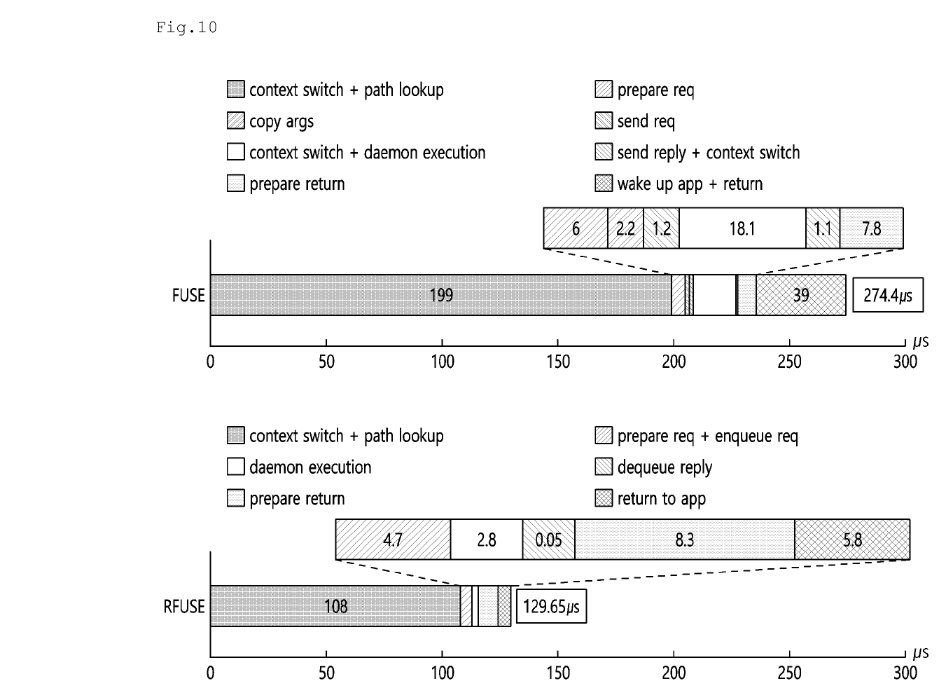

FIGS. 10, 11 and 12a to 12f are comparison tables comparing performances of existing algorithms with those of an embodiment of the disclosure.

Referring to FIG. 10, a diagram on the top is a schematic diagram showing an execution time of an operation performed in an existing FUSE framework, and a diagram on the bottom is a schematic diagram showing an execution time of an operation performed in an RFUSE framework according to one embodiment of the present disclosure. As shown, an operation that requires 274.4 μs in the existing FUSE framework is completed in only 129.65 μs in the RFUSE framework according to one embodiment, resulting in an overall time reduction of approximately 53%.

In more detail, while the existing FUSE requires 18.1 μs in the context switch and daemon execution process, the RFUSE may shorten it to 2.8 μs by improving context switch and implementing only daemon execution. In addition, while the time required to wake up and return an application in a sleep state is 39 μs in the existing FUSE, the RFUSE has an advantage of shortening the time required to return to the application to 5.8 μs by improving the overhead of the sleep-wakeup process. In addition, the existing FUSE requires 199 μs for path search (context switch + path lookup), but the RFUSE may improve this to shorten it to 108 μs. These individual improvements may be accumulated to reduce the overall time by about 53%.

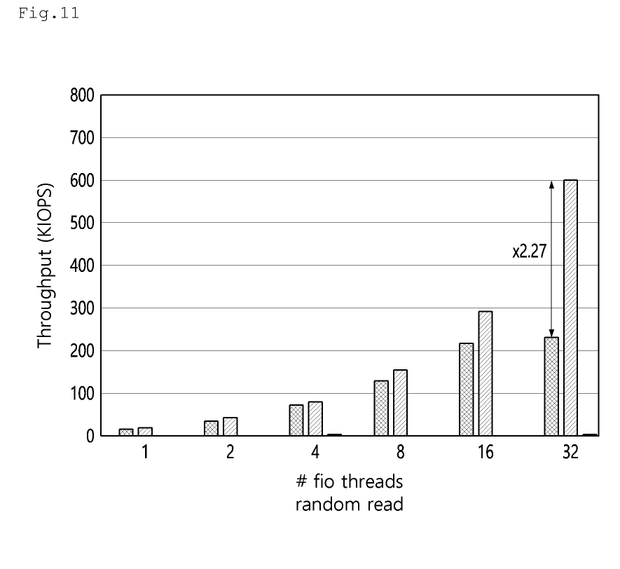

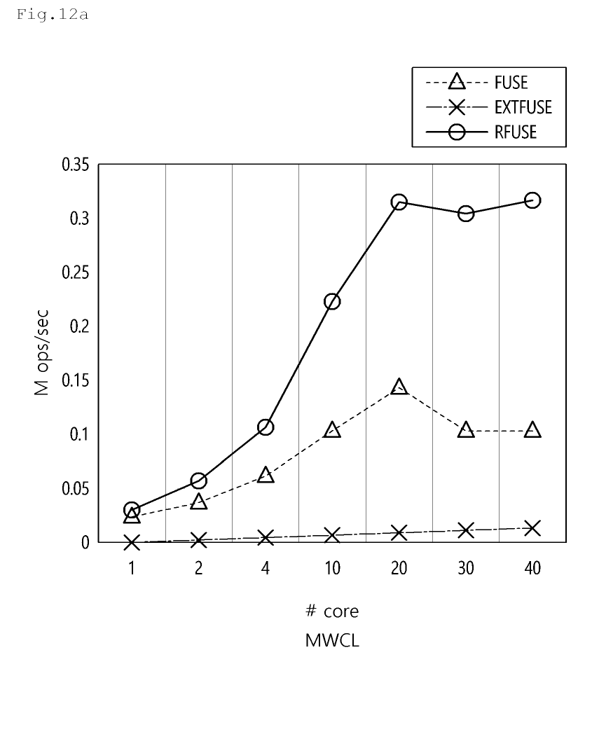

FIG. 11 is a diagram showing an effect of improving a throughput of an RFUSE according to one embodiment of the present disclosure compared to that of an existing FUSE in performing a random read request. The test results shown in FIG. 11 are compared with the results of the FIO benchmark for StackFS as a number of threads increases. As shown in FIG. 11, an RFUSE according to one embodiment of the present disclosure shows a more pronounced difference as a number of threads increases compared to an existing FUSE, and when tested for 32 threads, an effect of improvement in throughput may be obtained by about 2.27 times.

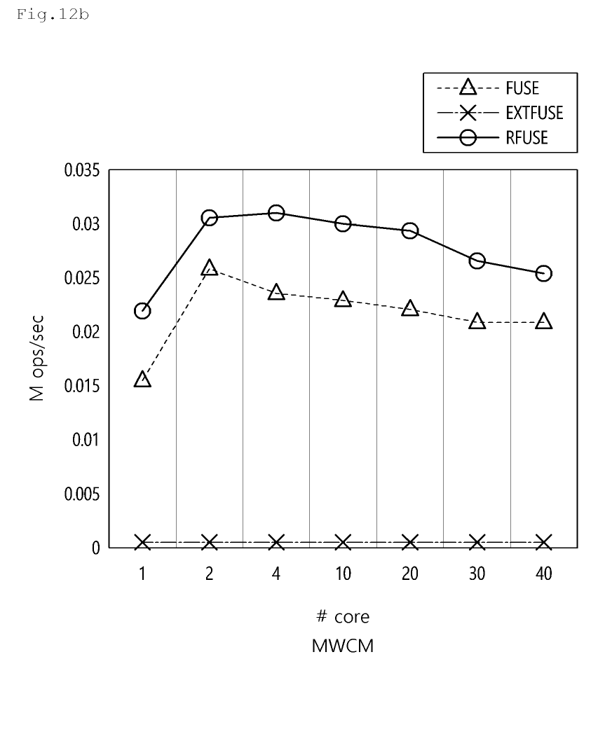

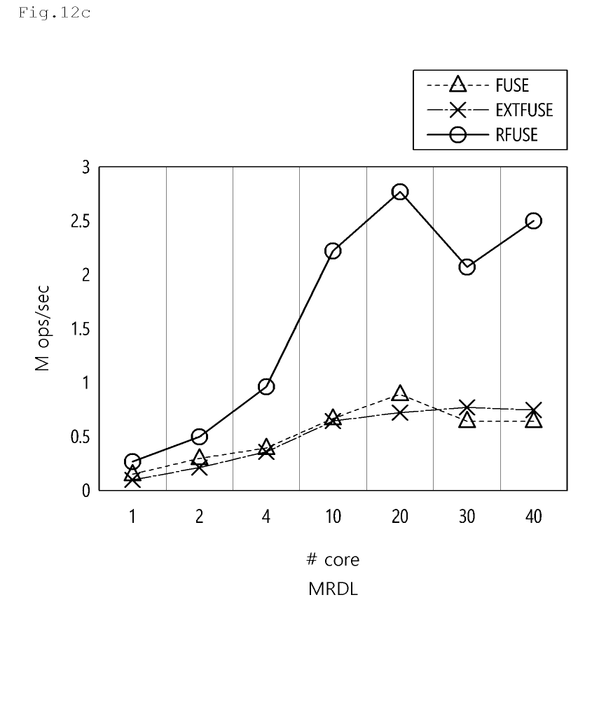

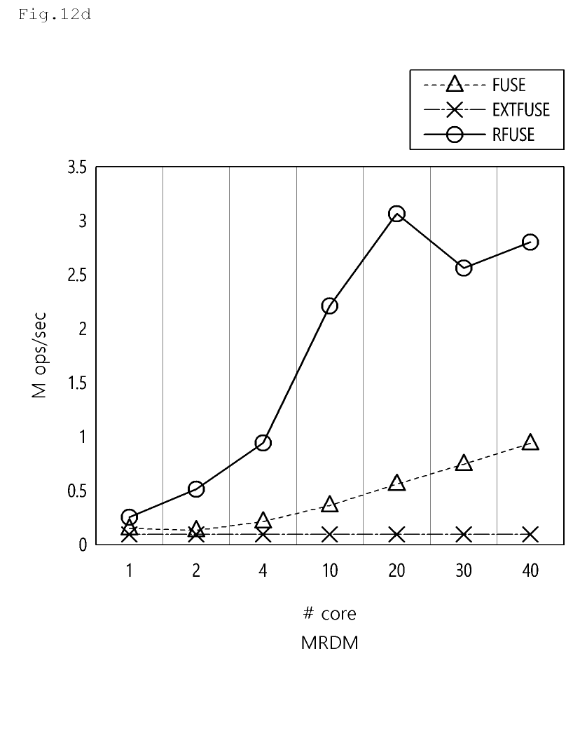

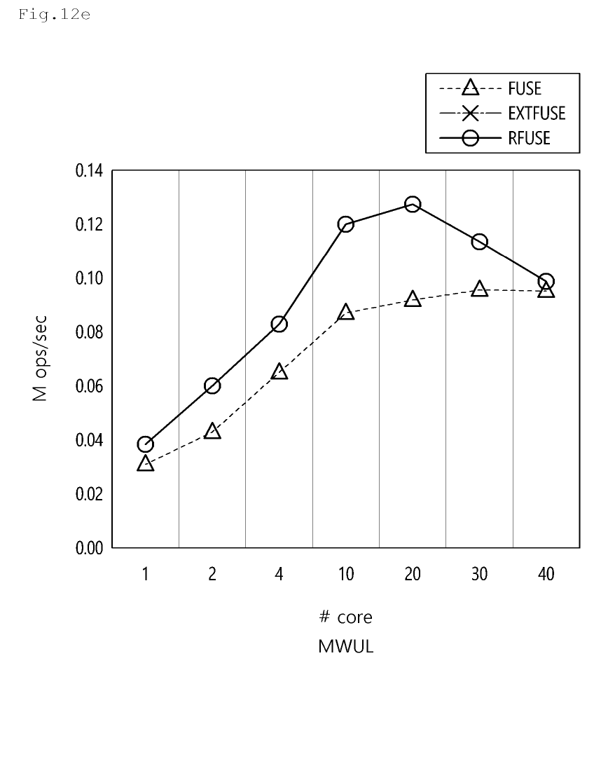

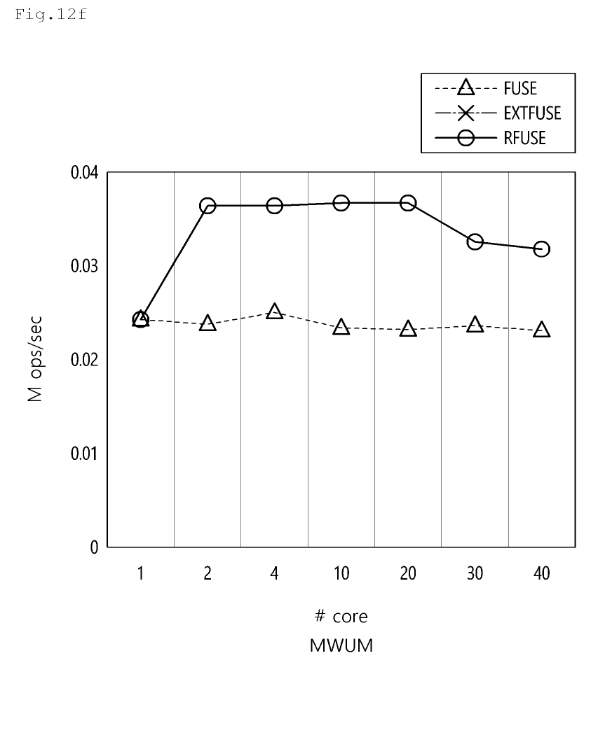

FIG. 12 is diagrams showing an effect of improving a throughput of an RFUSE according to one embodiment of the present disclosure compared to those of existing FUSE and EXTFUSE in performing create, list up, and delete requests. The test results shown in FIG. 12 are comparison results of the FXMARK benchmark for StackFS. (a) of FIG. 12 is a comparison result for a request to generate a file in a private directory, (b) is a comparison result for a request to create a file in a shared directory, (c) is a comparison result for a request to enumerate a file in a private directory, (d) is a comparison result for a request to enumerate a file in a shared directory, (e) is a comparison result for a request to unlink in a private directory, and (f) is a comparison result for a request to unlink in a shared directory. As shown in FIG. 12, an RFUSE shows an effect of improved throughput in all tested areas compared to existing algorithms.

By utilizing the various embodiments of the present disclosure described above, an RFUSE framework also has significant commercial value for global cloud service providers (AWS, Google Cloud, Microsoft Azure, etc.). The storage market is already highly active, and driven by high demand and technological advancements through global cloud service providers and large-scale data center operators. Among them, a userspace filesystem plays a crucial role in cloud-based data processing and distributed filesystem construction, and the related market is continuously expanding. Although the FUSE has already been widely adopted to implement a userspace filesystem centered on an open-source ecosystem, the problem of solving performance bottlenecks due to internal structural limitations has emerged as a major challenge. Therefore, the RFUSE framework according to embodiments of the present disclosure that improves this may dramatically improve performance and scalability while maintaining perfect compatibility with the existing FUSE-based filesystem. For example, the RFUSE may provide high performance while still using the existing FUSE API set, thus allowing developers and enterprises to utilize the technology at no additional development cost, and accelerating market adoption. In addition, the RFUSE may provide scalability in a high-performance storage environment, allowing it to operate efficiently in a modern hardware environment.

Additionally, the RFUSE according to an embodiment of the present disclosure is a software-based solution, which is easy to replicate and distribute, unlike mass production of physical products. This allows rapid deployment in a cloud service or data center environment, and is cost-effective as it can be integrated into an existing infrastructure without additional hardware.

Additionally, the RFUSE according to an embodiment of the present disclosure is particularly useful for enterprises that require high-performance data processing and efficient filesystem management. For example, cloud service providers, data center operators, and enterprises that provide large-scale storage solutions may be major consumers. In addition, enterprises that use a userspace filesystem to process an AI and machine learning workload may also benefit from the performance improvement of the RFUSE.

As such, various embodiments of the present disclosure may be optimized for utilization in a hardware environment requiring high performance by applying a scalable communication method for a userspace filesystem framework.

It should be understood that various embodiments of the disclosure and terms used herein are not intended to limit the technical features described in the disclosure to specific embodiments, and include various modifications, equivalents, or alternatives of the embodiments. With regard to the description of the drawings, similar reference numerals may be used for similar or related elements. A singular form of a noun corresponding to an item may include one or more of the things, unless the relevant context clearly indicates otherwise.

In the disclosure, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. Terms such as "1st", "2nd", or "first", and "second" may be used merely to differentiate a corresponding element from another, and do not limit the elements in any other aspect (e.g., importance or order). When an element (e.g., a first element) is referred to as being "coupled" or "connected" to another element (e.g., a second element), with or without the term "functionally" or "communicatively," it means that the element may be connected to the other element directly (e.g., in a wired manner), in a wireless manner, or through a third element.

The term "module" as used in the disclosure may include a unit implemented in hardware, software or firmware, and may be used interchangeably with terms such as logic, logic block, component, or circuit. A module may be an integrally configured component or a minimum unit of the component that performs one or more functions or a part thereof. For example, according to one embodiment, the module may be implemented in a form of an application-specific integrated circuit (ASIC).

Various embodiments of the disclosure may be implemented as software (e.g., a program) including one or more instructions stored in a storage medium (e.g., a memory) that is readable by an apparatus (e.g., an electronic apparatus). The storage medium may include a random access memory (RAM), a memory buffer, a hard drive, a database, an erasable programmable read-only memory (EPROM), an electrically erasable read-only memory (EEPROM), a read-only memory (ROM), and/or the like.

In addition, a processor in embodiments of the disclosure may retrieve at least one instruction from among one or more instructions stored from a storage medium and execute the retrieved instruction. This allows the device to operate to perform at least one function according to the retrieved at least one instruction. The one or more instructions may include a code created by a compiler or a code executable by an interpreter. The processor may be a general purpose processor, a field programmable gate array (FPGA), an application specific integrated circuit (ASIC), a digital signal processor (DSP), and/or the like.

The device-readable storage medium may be provided in a form of a non-transitory storage medium. Here, the term 'non-transitory' simply means that the storage medium is a tangible apparatus and does not include a signal (e.g. electromagnetic waves), and this term does not differentiate between a case where data is stored semi-permanently and a case where the data is temporarily on the storage medium.

A method according to various embodiments disclosed in the disclosure may be included and provided in a computer program product. The computer program product may be traded as a commodity between a seller and a buyer. The computer program product may be distributed in a form of an apparatus-readable storage medium (e.g., compact disc read only memory (CD-ROM)), or be distributed (e.g., downloaded or uploaded) online via an application store (e.g., PlayStore) or directly between two user apparatuses (e.g., smartphones). In the case of online distribution, at least part of the computer program product may be at least temporarily stored or temporarily created in the device-readable storage medium, such as a manufacturer's server, a server of an application store, or a server's memory.

According to various embodiments, each element (e.g., a module or a program) of the above-described elements may include a single entity or a plurality of entities. According to various embodiments, one or more of the aforementioned elements or operations may be omitted, or one or more other elements or operations may be added. Alternatively or additionally, the plurality of elements (e.g., modules or programs) may be integrated into a single element. In such a case, the integrated element may perform one or more functions of each of the plurality of elements in the same or similar manner to those performed by a corresponding one of the plurality of elements prior to the integration. According to various embodiments, operations performed by a module, a program or another element may be executed sequentially, in parallel, repeatedly, or heuristically, or one or more of the operations may be executed in a different order, omitted, or one or more other operations may be added.

### DESCRIPTION OF SYMBOLS

100: Apparatus

110: Memory

120: Processor

130: Input/output interface

140: Communication interface

310: RFUSE driver

320: RFUSE daemon

330: Application

340: VFS

380: Ring channel

381: Background queue

382: Circular queue

383: Header buffer

384: Argument buffer

What is claimed is:

1. A scalable kernel-userspace communication method for a userspace filesystem framework performed by a processor comprising a plurality of cores, the method comprising:
performing, by an application, a filesystem request;
receiving, by a kernel space driver, the request;
transmitting, by the kernel space driver, the request to a userspace daemon using at least one of a plurality of ring channels respectively corresponding to the plurality of cores - each of the plurality of ring channels comprising a circular queue having a fixed size -;
processing, by the userspace daemon, the request, and returning a result of the processing to the kernel space driver; and
returning, by the kernel space driver, the result of the processing to the application.

2. The method of claim 1, wherein the plurality of cores are classified as non-uniform memory access (NUMA) nodes, and
wherein the ring channel is implemented on a memory of the NUMA node comprising a core corresponding thereto.

3. The method of claim 1, wherein the plurality of ring channels are implemented through a shared memory between the kernel space driver and the userspace daemon.

4. The method of claim 1, wherein processing, by the userspace daemon, the request, comprises allocating a dedicated worker thread to each of the plurality of ring channels to process the request.

5. The method of claim 1, wherein the circular queue implements at least one of a pending queue and a processing queue.

6. The method of claim 5, further comprising:
directly storing, when the request is a synchronous request, the request in the circular queue, and storing, when the request is an asynchronous request, the request in a background queue implemented outside the ring channel, and then moving the request to the circular queue.

7. The method of claim 5, wherein the plurality of ring channels comprise a header buffer and an argument buffer for storing filesystem request information associated with the request.

8. The method of claim 7, wherein the header buffer and the argument buffer comprise a bitmap for managing entry allocation information.

9. The method of claim 7, wherein the header buffer comprises a first entry storing basic information of the request and a second entry storing individually required information according to the request.

10. The method of claim 7, wherein the argument buffer is used for the request to transmit one or more additional parameters.

11. The method of claim 7, wherein the ring channel comprising the circular queue, the header buffer and the argument buffer is mapped to a virtual address space of the userspace daemon.

12. The method of claim 1, wherein the kernel space driver uses hybrid polling to receive the result of the processing for the request for a preset period of time.

13. The method of claim 12, wherein the hybrid polling falls back, when the result of the processing for the request is not received for the preset period of time, to an event-wait mode.

14. The method of claim 1, further comprising:
determining whether the request is concentrated on a single ring channel to cause congestion.

15. The method of claim 14, further comprising:
scheduling, when it is determined that congestion has caused, a plurality of requests of a ring channel in which the congestion has caused to another ring channel in a round-robin manner.

16. The method of claim 14, comprising:
storing, when the request is an asynchronous request, the request in a background queue implemented outside the ring channel,
wherein a criterion for determining that the congestion has caused determines that a number of asynchronous requests stored in the background queue exceeds a preset threshold that can be stored in the circular queue at most.

17. The method of claim 14, wherein the kernel space driver uses hybrid polling to receive the result of the processing for the request for a preset period of time,
wherein when the result of the processing for the request is not received for the preset period of time, the hybrid polling falls back to an event-wait mode, and
wherein a criterion for determining that the congestion has caused comprises determining that there is an application that has fallen back to the event-wait mode.

18. An apparatus for scalable kernel-userspace communication for a userspace filesystem framework, the apparatus comprising:
a memory including an instruction; and
a processor having a plurality of cores that performs a predetermined operation based on the instruction,
wherein the operation of the processor comprises the operations of:
performing, by an application, a filesystem request;
receiving, by a kernel space driver, the request;
transmitting, by the kernel space driver, the request to a userspace daemon using at least one of a plurality of ring channels respectively corresponding to the plurality of cores - each of the plurality of ring channels comprising a circular queue having a fixed size -;
processing, by the userspace daemon, the request, and operation of a result of the processing to the kernel space driver; and
returning, by the kernel space driver, the result of the processing to the application.

19. A computer program stored in a non-transitory computer-readable recording medium, the computer program comprising:
when performed on at least one processor comprising a plurality of cores,
an instruction that allows the processor to perform the operations of:
performing, by an application, a filesystem request;
receiving, by a kernel space driver, the request;
transmitting, by the kernel space driver, the request to a userspace daemon using at least one of a plurality of ring channels respectively corresponding to the plurality of cores - each of the plurality of ring channels comprising a circular queue having a fixed size -;
processing, by the userspace daemon, the request, and operation of a result of the processing to the kernel space driver; and
returning, by the kernel space driver, the result of the processing to the application.
